(19) United States
(12) Patent Application Publication
(10) Pub. No.: US 2023/0028766 A1
(43) Pub. Date: Jan. 26, 2023

(54) LOW-COMPLEXITY METHOD FOR MITIGATING AND COMPENSATING NONCAUSAL CHANNEL EFFECTS

(71) Applicant: ASELSAN ELEKTRONIK SANAYI VE TICARET ANONIM SIRKETI, Ankara (TR)

(72) Inventors: Altug KAYA, Ankara (TR); Gokhan Muzaffer GUVENSEN, Ankara (TR)

(73) Assignee: ASELSAN ELEKTRONIK SANAYI VE TICARET ANONIM SIRKETI, Ankara (TR)

(21) Appl. No.: 17/785,060

(22) PCT Filed: Jun. 23, 2020
(86) PCT No.: PCT/TR2020/050540

§ 371 Date: Jun. 14, 2022

(30) Foreign Application Priority Data
May 6, 2020 (TR) 2020/07096

(51) Int. Cl. H04L 25/03; H04L 27/26

(52) U.S. Cl. CPC H04L 25/03012; H04L 27/2605

(57) ABSTRACT

The resulting two-sided ISI effect can be migrated to an equivalent noncausal communication channel. Then, a method for mitigating two-sided ISI and compensating the noncausal channel effect is proposed. The method includes insertion and removal of CP and CS. When CS and CP are inserted at transmitter and removed at receiver in block transmission-based communication systems, it is possible to generate a circulant convolution matrix for noncausal communication channel. In addition, the method includes equalization of a noncausal communication channel in block transmission-based communication systems when the channel state information is available at the receiver.

### CROSS REFERENCE TO THE RELATED APPLICATIONS

This application is the national phase entry of International Application No. PCT/TR2020/050540, filed on Jun. 23, 2020, which is based upon and claims priority to Turkish Patent Application No. 2020/07096, filed on May 6, 2020, the entire contents of which are incorporated herein by reference.

### TECHNICAL FIELD

The present invention relates to a method for mitigating inter-symbol interference (ISI) with post- and pre-cursors (also known as two-sided ISI) caused by noncausal communication channels in block transmission-based communication systems. In addition, the present invention relates to equalization of noncausal communication channels in block transmission-based communication systems when the channel state information is available at the receiver.

### BACKGROUND

In wireless communication systems, the transmitted signals may suffer from dispersive causal communication channels, also known as multipath channels. After a transmitted signal propagates through such causal channels, the received signal becomes superposition of different echoes and reflections of the transmitted signal. Generally, these causal channels are modelled by linear discrete-time tapped delay-line model:

$$y [ i ] = {\sum }_{l = 0}^{L - 1} h [ l ] \times [ i - l ] + n [ i ] \qquad ( 1 )$$

where y[i] represents received symbols, x [i] represents transmitted symbols, n[i] represents additive noise for every symbol, h[i] represents time domain tap coefficients (hereinafter tap coefficients) of channel in use, and L represents delay spread of the channel. Due to channel memory, the transmitted symbol interferes with subsequent symbols. Such symbols affect the transmitted symbol same as noise and degrade reliability of communication systems. This phenomenon is known as inter-symbol interference (ISI). ISI is also known as post-cursor ISI or one-sided ISI.

Transmitter can prevent such degradations by introducing a guard interval between subsequent information block, called cyclic prefix (CP), in a block transmission-based communication system. Insertion of CP corresponds to extending an information block by copying a rear portion and inserting the copied portion to the beginning of the same information block. CP insertion presumes the system of interest has a causal impulse response and CP can be utilized when there is only one-sided ISI present. This conventional technique neglects systems having noncausal impulse responses. Thus, for example, CP cannot be used to resolve ISI caused by noncausal channels (two-sided ISI) completely.

In FIG. 1, an information block (10) transforms into an information block extended with CP (20) after CP insertion at the transmitter. If the length of CP is greater than or equal to the (causal) channel delay spread, then one-sided ISI can be prevented when the CP is removed at the receiver. In FIG. 2, received information block extended with CP (30) transforms into information block (10) after CP removal at the receiver. Moreover, when CP length is greater than or equal to (causal) channel delay spread, insertion at transmitter and removal at receiver of CP converts the Toeplitz convolution matrix of the channel into a circulant one.

The importance of circulant matrices stem from their diagonalization: the discrete Fourier transform (DFT) diagonalizes the circulant matrix. A diagonal channel convolution matrix identifies a channel with M, namely the number of transmitted symbols, sub-channels uncorrelated from each other. With fast Fourier transform (FFT), the resulting channel can be regarded as flat over each subcarrier. Thus, in frequency domain each sub-channel can be equalized, independently, by a frequency domain equalizer (FDE).

Pulse shaping mismatches, synchronization errors, and nonlinear effects can be modelled as noncausal channels in block transmission-based communication systems. Due to noncausal impulse responses of these channels, the transmitted symbol is interfered by succeeding and preceding symbols. Such symbols affect the transmitted symbol same as noise and degrade reliability of communication systems. In the next generation communication systems, even low-powered effects can degrade the performance of transceivers. Thus, the resulting two-sided ISI, regardless of having weakly powered pre-cursor ISI, should be mitigated at the receiver.

The application numbered GB2463508B is related with a block transmission method involving the use of time reversal and CP and cyclic suffix (CS). Said method discusses insertion and removal of CP/CS in OFDM and SCFDE systems in such a way that the resulting frequency coefficients of the equivalent channel are real-valued. However, the mentioned patent is removing the previously inserted CP and CS in a completely different way than in the present invention. The mentioned patent proposes a removal process of a combined length of CS and CP from the head of the received information block, only. That mentioned patent aims to acquire real-valued frequency domain channel coefficients in a time reversal system. This acquisition is used to employ arbitrary number of multiple transmit antennas for achieving full rate Orthogonal Space-Time Block Coding for real or complex-valued signaling in the mentioned patent above. There is no specific intention for generating circulant convolution matrices for noncausal channels in the abovementioned patent. In addition, in the present invention, it is assumed that the channel state information is available at the receiver whereas the channel state information in the abovementioned patent is required at the transmitter, which can be disadvantageous due to having another channel, namely feedback channel.

The use of CP and/or CS in OFDM for the purpose of precise timing synchronization is detailed in application numbered WO2006/019255, “Method for detecting OFDM symbol timing in OFDM systems”. However, no receiver structure is discussed in the mentioned patent. There is no specific description of how CP and/or CS is removed at the receiver. In addition, that patent uses a transmit block structure only for OFDM and only for performing precise symbol timing detection. There is no specific intention for equalizing noncausal communication channels. In the present embodiment, however, this block structure is used together with CP and CS removal at the receiver to generate a circulant convolution matrix for noncausal communication channels in block transmission-based communication systems. Moreover, the present embodiment is independent from the kind of modulation type in use as long as CP and CS insertion and removal are held in time domain.

### SUMMARY

In the present invention, the resulting two-sided ISI effect is migrated to an equivalent noncausal communication channel. Then, a method for mitigating two-sided ISI and compensating the noncausal channel effect is proposed. The method comprises insertion and removal of CP and CS. When CS and CP are inserted at transmitter and removed at receiver in block transmission-based communication systems, it is possible to generate a circulant convolution matrix for noncausal communication channel. In addition, the method comprises equalization of a noncausal communication channel in block transmission-based communication systems when the channel state information is available at the receiver.

### BRIEF DESCRIPTION OF THE FIGURES

FIG. 1 illustrates schematically insertion of a cyclic prefix at transmitter in conventional block transmission-based communication systems.

FIG. 2 illustrates schematically removal of a cyclic prefix at receiver in conventional block transmission-based communication systems.

FIG. 3 illustrates schematically insertion of a cyclic suffix at transmitter in accordance with the specific embodiment of the invention in block transmission-based communication systems.

FIG. 4 illustrates schematically insertion of a cyclic prefix and a cyclic suffix at transmitter in accordance with the specific embodiment of the invention in block transmission-based communication systems.

FIG. 5 illustrates schematically removal of a cyclic prefix and a cyclic suffix at receiver in accordance with the specific embodiment of the invention in block transmission-based communication systems.

FIG. 6 illustrates schematically how blocks of information is generated and transmitted at transmitter in accordance with the specific embodiment of the invention in block transmission-based communication systems.

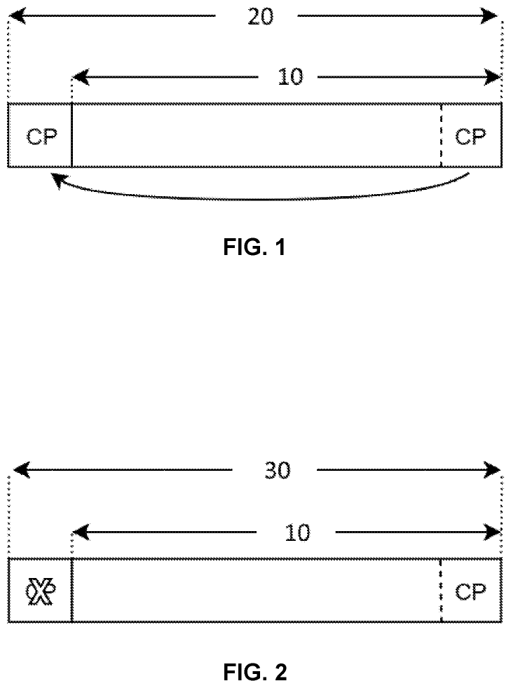

### PART REFERENCES

70. Information block
80. Information block extended with CP
90. Received information block extended with CP
100. Information block extended with CS
110. Information block extended with CP and CS
120. Received information block extended with CP and CS

CP: Cyclic prefix

CS: Cyclic suffix

### DETAILED DESCRIPTION OF THE EMBODIMENTS

Linear and Time-Invariant (LTI) systems can be completely characterized by their impulse responses. Causal impulse responses' time domain taps (hereinafter taps) can be grouped into two: main-cursor tap and post-cursor taps. Noncausal impulse responses' taps, however, can be grouped into three: pre-cursor taps, main-cursor tap, and post-cursor taps.

Noncausal LTI systems can be observed by multiple reasons. Some of the examples are:
When a root-raised cosine (RRC) filter is selected as a pulse shaping filter at transmitter, then another RRC filter can be employed as a matched filter at receiver side. In an idealized communication system, an equivalent filter of these two RRC filter becomes raised cosine (RC) filter. RC filter satisfies Nyquist ISI criterion and eliminates inter-symbol interference (ISI). However, idealized RRC filters are in infinite length. Realizable filters' impulse response is of finite length and has to be causal. Hence, for realizing a RRC filter the impulse response of a RRC filter should be truncated by multiplying with a rectangular windowing function in time domain. When truncated RRC filters are both used in transmitter and receiver, the equivalent filter does not become a RC filter. Rather, the equivalent filter comprises three cascaded filters: a RC and two additional filters whose frequency responses are sinc functions. This equivalent filter cannot satisfy Nyquist ISI criterion and the resulting systems frequency response does not have a flat fading characteristic. Instead, the equivalent filter's impulse response becomes noncausal with the existence of low powered pre-cursor taps which results in two-sided ISI. This equivalent filter can be considered as an equivalent noncausal channel.
Time synchronization (also known as symbol synchronization) is, arguably, one of the most important tasks at receivers. If the received signal is not sampled at the correct instance, time synchronization errors will occur and this cause two-sided ISI. Modeling of time synchronization errors can be migrated from receiver to channel by utilizing an equivalent noncausal communication channel with low powered pre-cursor taps.
Nonlinear distortions may also appear as one-sided ISI at the matched filter output. It also strengthens one or two-sided ISI that has already been existed. Thus, modelling of nonlinear distortions can also be migrated from receiver to channel by utilizing an equivalent noncausal communication channel with low powered pre-cursor taps.

These examples are not essential for employing the methods proposed in the present invention. The focuses of the present invention are about mitigating two-sided ISI and compensating noncausal communication channel effects when frequency domain channel coefficients are available at the receiver.

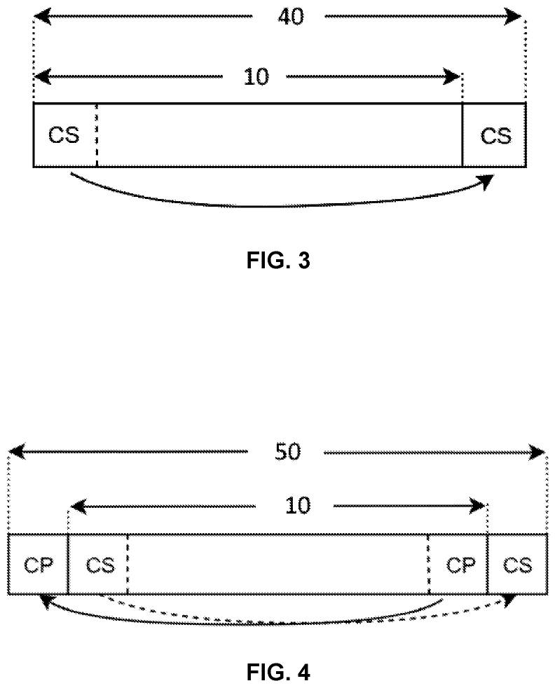

The present invention utilizes CS together with CP to mitigate two-sided ISI for the next generation communication systems and to generate circulant convolution matrices for noncausal channels. Insertion of CS corresponds to extending an information block by copying a front portion and inserting the copied portion to the end of the same information block. In FIG. 3, an information block (10) transforms into information block extended with CS (40) after CS insertion at the transmitter.

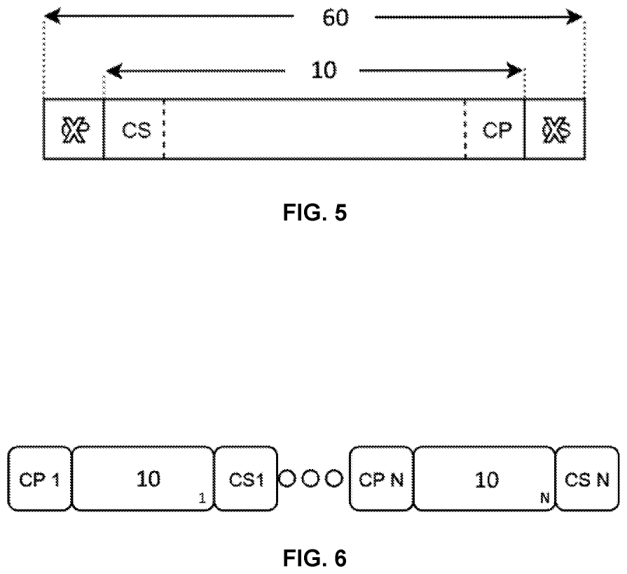

Insertion of CP and CS corresponds to extending an information block by copying rear and front portions and inserting the copied portions to the beginning and to the end of the same information block, respectively. In FIG. 4, an information block (10) transforms into information block extended with CP and CS (50) after CP and CS insertion at the transmitter. If the length of CP is greater than or equal to the number of post-cursor taps of the noncausal channel and the length of CS is greater than or equal to the number of pre-cursor taps of the noncausal channel, then two-sided ISI can be mitigated when CP and CS are removed at the receiver. In FIG. 5, received information block extended with CP and CS (60) transforms into an information block (10) after CP and CS removal at the receiver. Moreover, when CP length is greater than or equal to the number of post-cursor taps of the noncausal channel and CS length is greater than or equal to the number of pre-cursor taps of the noncausal channel, insertion of CP and CS at transmitter and removal of CP and CS at receiver converts the Toeplitz convolution matrix of a noncausal channel into a circulant convolution matrix of a noncausal channel. Circulant convolution matrices will ease the channel estimation and frequency domain equalization by enabling FFT to transform time domain information blocks into frequency domain. To equalize the channel, receiver needs to employ a channel identification process. In the present invention it is assumed that the frequency domain channel coefficients are available at the receiver.

For demonstrating the mitigation of two-sided ISI, the generation of circulant convolution matrices for noncausal channels, the channel equalization, an implementation of the present invention will be shown. It is important to note that the channel estimation in the implementation is based on training. In the proposed method, however, it is assumed that the frequency domain channel coefficients are available at the receiver. In the implementation discrete time output of a noncausal LTI system can be written as:

$$y [ m ] = {\sum }_{l = - {L}_{b}}^{{L}_{f} - 1} h [ l ] \times [ m - l ] + n [ m ] \qquad ( 2 )$$

In equation 2, h[m] represents the tap coefficients of the noncausal channel, x [m] represents the elements in a transmitted information block, y [m] represents the elements in a received information block, and n[m] represents the additive noise for every element. Moreover, L_{f} represents the number of post-cursor and main taps of the noncausal impulse response, L_{b} represents the number of pre-cursor taps of the noncausal impulse response and thus, total noncausal channel length becomes (L_{f}+L_{b}). L_{f} and L_{b} can be any nonnegative number, as long as −L_{b}<L_{f}−1. In other words, equation 2 holds for channel lengths greater than or equal to one.

If the observations from equation 2 are written into a matrix-vector form:

$$[ \begin{matrix}y [ 0 ] \\ y [ 1 ] \\ ⋮ \\ y [ M - 1 ]\end{matrix} ] = \qquad ( 3 )$$

$$[ \begin{matrix}h [ {L}_{f} - 1 ] & … & h [ 1 ] & h [ 0 ] & h [ - 1 ] & … & h [ - {L}_{b} ] & 0 & … & 0 \\ 0 & h [ {L}_{f} - 1 ] & … & h [ 1 ] & h [ 0 ] & h [ - 1 ] & … & h [ - {L}_{b} ] & … & 0 \\ ⋮ & ⋱ & ⋱ & ⋱ & ⋱ & ⋱ & ⋱ & ⋱ & ⋱ & ⋮ \\ 0 & … & 0 & h [ {L}_{f} - 1 ] & … & h [ 1 ] & h [ 0 ] & h [ - 1 ] & … & h [ - {L}_{b} ]\end{matrix} ] [ \begin{matrix}x [ - {L}_{f} + 1 ] \\ x [ - {L}_{f} + 2 ] \\ ⋮ \\ x [ - 1 ] \\ x [ 0 ] \\ x [ 1 ] \\ ⋮ \\ x [ {L}_{b} - 2 ] \\ x [ {L}_{b} - 1 ] \\ ⋮ \\ x [ M - 1 ] \\ x [ M ] \\ x [ M + 1 ] \\ ⋮ \\ x [ M + {L}_{b} - 1 ]\end{matrix} ] +$$

$$[ \begin{matrix}n [ 0 ] \\ n [ 1 ] \\ ⋮ \\ n [ M - 1 ]\end{matrix} ]$$

where “M” represents the number of elements in an information block. The matrix contains h[l] is the Toeplitz convolution matrix of the noncausal channel. A CP insertion of length (L_{f}−1) corresponds to indicating x[−1]=x[M−1], x[−2]=x[M−2], . . . ,x[−(L_{f}−1)]=x[M−(L_{f}−1)]. In order to generate a circulant convolution matrix for the abovementioned noncausal channel, as the invention suggests a CS length of L_{b} can be inserted. Such a CS insertion corresponds to indicating x[M]=x[0], x[M+1]=x[1], . . . , x[M L_{b}−1]=x[L_{b}−1]. Now, if equation 3 is rewritten with the mentioned CP and CS insertion, the following matrix-vector equation will be:

$$[ \begin{matrix}y [ 0 ] \\ y [ 1 ] \\ ⋮ \\ y [ M - 1 ]\end{matrix} ] = \qquad ( 4 )$$

$$[ \begin{matrix}h [ 0 ] & h [ - 1 ] & h [ - 2 ] & … & h [ - {L}_{b} ] & 0 & … & 0 & h [ {L}_{f} - 1 ] & … & h [ 2 ] & h [ 1 ] \\ h [ 1 ] & h [ 0 ] & h [ - 1 ] & h [ - 2 ] & … & h [ - {L}_{b} ] & 0 & … & 0 & h [ {L}_{f} - 1 ] & … & h [ 2 ] \\ ⋮ & ⋱ & ⋱ & ⋱ & ⋱ & ⋱ & ⋱ & ⋱ & ⋱ & ⋱ & ⋱ & ⋮ \\ h [ - 2 ] & h [ - 3 ] & … & h [ - {L}_{b} ] & 0 & … & 0 & h [ {L}_{f} - 1 ] & … & h [ 1 ] & h [ 0 ] & h [ - 1 ] \\ h [ - 1 ] & h [ - 2 ] & h [ - 3 ] & … & h [ - {L}_{b} ] & 0 & … & 0 & h [ {L}_{f} - 1 ] & … & h [ 1 ] & h [ 0 ]\end{matrix} ]$$

$$[ \begin{matrix}x [ 0 ] \\ x [ 1 ] \\ ⋮ \\ x [ M - 1 ]\end{matrix} ] + [ \begin{matrix}n [ 0 ] \\ n [ 1 ] \\ ⋮ \\ n [ M - 1 ]\end{matrix} ]$$

The matrix contains h[l]'s becomes a circulant convolution matrix for the noncausal channel.

Equation 4 can be rewritten as follows:

y=Hx+n (5)

where y is the vector representation of the elements in a received information block without CP and CS, H represents the Toeplitz convolution matrix for communication channel, x is the vector representation of the elements in a transmitted information block without CP and CS, and n is the vector representation of the additive noise for every element. If the communication channel has causal characteristics (if L_{b}=0 in equation 2), then for generating a circulant convolution matrix for the causal channel a CP length greater than or equal to (L_{f}−1) should be inserted to the information blocks at transmitter and removed from the received information blocks at receiver. If the communication channel has noncausal characteristics (if L_{b}>1 in equation 2), in order to generate a circulant convolution matrix for the noncausal channel a CP length greater than or equal to (L_{f}−1) and a CS length greater than or equal to L_{b} should be inserted at transmitter and removed at receiver.

If a noncausal channel is present with L_{f} number of post-cursor and main taps, L_{b} number of pre-cursor taps and if a CP length greater than or equal to (L_{f}−1) and a CS length greater than or equal to L_{b} are inserted at transmitter and removed at receiver, then equation 5 can be rewritten in time domain for multiple information blocks as follows:

yᵢ[m]=\tilde{h}[m] [symbol] xᵢ[m]+nᵢ[m], m=0, . . . , M−1i=1, . . . ,N (6)

where \tilde{h}[m]=Σ_{k=-∞}^{∞}h[m−Mk], “ [symbol] ” represents the circular convolution, “m” represents the indexes of the elements in an information block, and subscript “i” represents the information block number, “yᵢ[m]” represents the m^{th} element in the i^{th} received information block, “xᵢ[m]” represents the m^{th} element in the i^{th} transmitted information block, “nᵢ[m]” represents the additive noise on the m^{th} element in the i^{th} information block, and “h[m]” represents the noncausal communication channel. In equation 6, the communication channel is stated without any subscript, because it is assumed the same across transmission blocks.

As a result of circular convolution in time domain, equation 6 can be written as a multiplication in frequency domain as follows:

$${Y}_{i} [ k ] = \frac{1}{\sqrt{M}} {\sum }_{m = 0}^{M - 1} {y}_{i} [ m ] {e}^{- j \frac{2 π}{M} km} , \tilde{H} [ k ] = \frac{1}{\sqrt{M}} {\sum }_{m = 0}^{M - 1} \tilde{h} [ m ] {e}^{- j \frac{2 π}{M} km} , {X}_{i} [ k ] = \frac{1}{\sqrt{M}} {\sum }_{m = 0}^{M - 1} {x}_{i} [ m ] {e}^{- j \frac{2 π}{M} km} , {N}_{i} [ k ] = \frac{1}{\sqrt{M}} {\sum }_{m = 0}^{M - 1} {n}_{i} [ m ] {e}^{- j \frac{2 π}{M} km} , {Y}_{i} [ k ] = \tilde{H} [ k ] {X}_{i} [ k ] + {N}_{i} [ k ] , k = 0 , … , M - 1 i = 1 , … , N \qquad ( 7 )$$

where “Yᵢ[k]” represents the frequency domain transformation of “yᵢ[m]” in equation 6, “\tilde{H}[k]” represents the frequency domain transformation of “\tilde{h}[m]” in equation 6, “Xᵢ[k]” represents the frequency domain transformation of “xᵢ[m]” in equation 6, “Nᵢ[k]” represents the frequency domain transformation of “nᵢ[m]” in equation 6, “k” represents the frequency bin indexes and subscript “i” still represents the information block number in equation 7. In equation 7, the frequency response of the communication channel, namely \tilde{H}[k], is stated without any subscript, because it is assumed the same across transmission blocks. Therefore, if a noncausal channel is present with L_{f} number of post-cursor and main taps, L_{b} number of pre-cursor taps and if a CP length greater than or equal to (L_{f}−1) and a CS length greater than or equal to L_{b} are inserted at transmitter and removed at receiver, then FFT can be used to transform information blocks from time domain to frequency domain. FFT size should be at least equal to the information block size, without CP and CS. For demonstration, FFT size is selected to be equal to the information block size, namely M, but it will be appreciated that this is not essential to the performance of the invention.

In the present invention, it is assumed that the frequency domain channel coefficients are available at the receiver. In this demonstration, the channel is estimated in frequency domain by training. However, this is not the only way of estimating communication channels. Communication channels can be estimated in frequency or time domain by different techniques, such as training, pilots, etc. In the present invention, any methodology of estimating communication channels in block transmission-based communication systems can be employed. As it was mentioned earlier, in this demonstration the channel is estimated in frequency domain by training. Thus, it is assumed that T number of transmitted information blocks, where T<<IV, are known by receiver and they are used for estimating the frequency response of the noncausal channel. Channel estimation is shown as follows:

$$\hat{H} [ k ] = \frac{1}{T} {\sum }_{i = 1}^{T} \frac{{X}_{i}^{*} [ k ]}{{\vert {X}_{i} [ k ] \vert}^{2}} {Y}_{i} [ k ] , k = 0 , … , M - 1 \qquad ( 8 )$$

where Ĥ[k] represents the estimated frequency response of the noncausal channel, superscript “*” represents the complex conjugate operation.

When the channel state information is available at the receiver, then a FDE can be employed in the present invention. Some examples of FDE are zero-forcing (ZF) equalization, minimum mean squared error equalization, FDE with frequency domain decision feedback, etc. For demonstration, a ZF is utilized, but it will be appreciated that this does not affect the performance of two-sided ISI mitigation and circulant convolution matrix generation for noncausal communication channels. ZF equalizer and its output will be written as follows:

$${\hat{X}}_{j} [ k ] = \frac{{\hat{H}}^{*} [ k ] {Y}_{j} [ k ]}{{\vert \hat{H} [ k ] \vert}^{2}} , k = 0 , … , M - 1 j = T + 1 , … , N \qquad ( 9 )$$

where “\hat{X}:ᵢ [k]” represents equalized kₜₕ frequency bin in the jₜₕ received information block that is affected by two-sided ISI and noncausal channel, and “Yⱼ [k]” represents kₜₕ frequency bin in the jₜₕ received information block that is affected by two-sided ISI and noncausal channel.

As it was mentioned earlier, in the present invention a method for mitigating two-sided ISI and compensating the noncausal channel effect is proposed. The method comprises insertion and removal of cyclic prefix, cyclic suffix, and equalization of noncausal communication channels in block transmission-based communication systems when frequency domain channel coefficients are available at the receiver. The present invention does not propose any kind of modulation type. Thus, after FDE the equalized versions of the received information blocks, namely “\hat{X}ⱼ [k]” in equation 9, can be transformed into time domain or it can be remained in frequency domain depending on the modulation type of choice.

To summarize, in this demonstration N information blocks are formed with M number of elements each at the transmitter. It is assumed that first T number of information blocks are known by receiver. Then, each information block is expanded with CP and CS insertion, and they are concatenated at transmitter as it is shown in FIG. 6. Then transmitter transmits. Receiver captures all the extended and concatenated information blocks, removes CP and CS. Following the removal of CP and CS, receiver transforms the received information blocks into frequency domain by FFT. Then, it uses the first T number of received information blocks to estimate the noncausal channel in frequency domain. Finally, the rest of the information blocks are equalized in frequency domain by an FDE. Resulting equalized frequency domain blocks can be transformed into time domain or they can be kept in frequency domain depending on the modulation type of choice, because the present invention is independent from modulation of choice.

All of the above aspects of the invention can be implemented by way of a computer program product, which may comprise computer executable instructions carried on a carrier medium. The carrier medium may comprise a storage product, or may comprise a signal, such as a download.

We claim:

1. A method for mitigating post-cursor and pre-cursor inter-symbol interference and generating circulant convolution matrices for noncausal communication channels in block transmission-based communication systems, comprising the steps of:
1) extending an information block with cyclic prefix (CP) and cyclic suffix (CS) at a transmitter,
2)transmitting the extended information block to a receiver,
3) removing the CP and CS from the extended information block received at the receiver.

2. The method according to claim 1, wherein the CP extension corresponds to copying a rear portion of the information block and inserting the copied portion to the beginning of the same information block in time domain.

3. The method according to claim 1, wherein a length of the CP is greater than or equal to a number of post-cursor taps of the noncausal communication channels.

4. The method according to claim 1, further comprising discarding a length of CP amount of information from a beginning of the extended information block received in time domain for removing the CP.

5. The method according to claim 1, wherein extending with the CS corresponds to copying a front portion of the information block and inserting the copied portion to an end of the same information block in time domain.

6. The method according to claim 1, wherein a length of the CS is greater than or equal to a number of pre-cursor taps of the noncausal communication channels.

7. The method according to claim 1, further comprising discarding a length of CS amount of information from an end of the extended information block received in time domain for removing the CS.

8. The method according to claim 1, wherein step 3 comprises:
transforming the received extended information block received into a frequency domain by fast Fourier transform (FFT),
equalizing a dispersive noncausal channel by a frequency domain equalizer when frequency domain channel coefficients are available at the receiver.

9. The method according to claim 2, wherein a length of the CP is greater than or equal to a number of post-cursor taps of the noncausal communication channels.

10. The method according to claim 2, further comprising discarding a length of CP amount of information from a beginning of the extended information block received in the time domain for removing the CP.

11. The method according to claim 3, further comprising discarding a length of CP amount of information from a beginning of the extended information block received in time domain for removing the CP.

12. The method according to claim 2, wherein extending with the CS corresponds to copying a front portion of the information block and inserting the copied portion to an end of the same information block in the time domain.

13. The method according to claim 3, wherein extending with the CS corresponds to copying a front portion of the information block and inserting the copied portion to an end of the same information block in time domain.

14. The method according to claim 4, wherein extending with the CS corresponds to copying a front portion of the information block and inserting the copied portion to an end of the same information block in time domain.

15. The method according to claim 2, wherein a length of the CS is greater than or equal to a number of pre-cursor taps of the noncausal communication channels.

16. The method according to claim 3, wherein a length of the CS is greater than or equal to a number of pre-cursor taps of the noncausal communication channels.

17. The method according to claim 4, wherein a length of the CS is greater than or equal to a number of pre-cursor taps of the noncausal communication channels.

18. The method according to claim 5, wherein a length of the CS is greater than or equal to a number of pre-cursor taps of the noncausal communication channels.

19. The method according to claim 2, further comprising discarding a length of CS amount of information from an end of the extended information block received in the time domain for removing the CS.

20. The method according to claim 3, further comprising discarding a length of CS amount of information from an end of the extended information block received in time domain for removing the CS.
